(19) United States
(12) Patent Application Publication
(10) Pub. No.: US 2008/0007838 A1
(43) Pub. Date: Jan. 10, 2008

(54) Field-of-view indicator, and optical system and associated method employing the same

(75) Inventors: Eugene Jude Pochapsky, Cheswick, PA (US); James Thomas Mourra, Pittsburgh, PA (US); Harry Andrew Beck, Sarver, PA (US)

Correspondence Address: DOCKET CLERK, P.O. DRAWER 800889, DALLAS, TX, 75380, US

(73) Assignee: OMNITECH PARTNERS, INC., Freeport, PA (US)

(21) Appl. No.: 11/825,289

(22) Filed: Jul. 5, 2007

Related U.S. Application Data
(60) Provisional application No. 60/819,066, filed on Jul. 7, 2006.

(51) Int. Cl. G02B 27/14

(52) U.S. Cl. 359/630

(57) ABSTRACT

A field-of-view indicator for use with a viewing device provides a user of the viewing device with a visible indication of a status or event. The viewing device is used by a user to view an image of a scene. An indicator mechanism is operable to display an indication to the user in at least a portion of the image. The indicator mechanism is located in a position such that, while viewing the image of the scene with the viewing device, the user does not view an image of the indicator mechanism. When not activated, the indicator mechanism does not block a portion of the user's view of the image of the scene. The indication may be a change in one of color and brightness of the portion of the image. A plurality of indications may be provided using one or more colors, flash rates, duty cycles, and intensities.

### CROSS-REFERENCE TO RELATED APPLICATION

This application claims priority under 35 USC 119(e) to U.S. provisional Application Ser. No. 60/819,066 filed on Jul. 7, 2006, and which is incorporated herein by reference.

### TECHNICAL FIELD

The present invention relates generally to indicators, and more particularly to a visible indicator in the field-of-view of a viewing device.

### BACKGROUND

An operator of a viewing device may desire to receive one or more indications while observing a scene through the viewing device. Such indications may include a status of the viewing device or associated equipment (such as battery charge level) or a notification of an event requiring action by the operator (such as an incoming communication).

The operator may further desire to receive the indication without removing his eye from the viewing device—that is, while continuing to view the scene using the viewing device. The operator may also desire that the indication not be visible to anyone other than himself. Such an operator may also require that the indication, and any mechanism for giving the indication, not block any portion of the scene being viewed.

Thus, it would be beneficial to provide an indication mechanism for a user of a viewing device that is visible to the user while viewing a scene through the viewing device, does not block the user's view of the scene, is only visible to the user, and can provide the user with more than one status or event.

Accordingly, there is needed a field-of-view indicator for use with a viewing device.

### SUMMARY

In accordance with one embodiment, there is provided an optical device that includes a viewing device and an indicator mechanism. The viewing device is used by a user to view an image of a scene. The indicator mechanism is operable to display an indication to the user in at least a portion of the image. The indicator mechanism is located in a position such that, while viewing the image of the scene with the viewing device, the user does not view an image of the indicator mechanism.

In accordance with another embodiment, there is provided a method that includes providing a viewing device that is operable by a user to view an image of a scene. The method also includes locating an indicator mechanism in a position relative to the viewing device such that, while viewing the image of the scene, the user does not view an image of the indicator mechanism. The method further includes displaying an indication to the user in at least a portion of the image using the indicator mechanism.

In yet another embodiment, there is provided an optical device that includes a viewing device and an indicator mechanism. The viewing device is used by a user to view an image of a scene. The viewing device has an optical axis, wherein the scene and the image are located on the optical axis. The indicator mechanism is operable to display an indication to the user within at least a part of the image of the scene. The indicator mechanism is located substantially on the optical axis of the viewing device in a position such that the viewing device does not form a focused image of the indicator mechanism.

In accordance with another embodiment, there is provided a viewing device with an optical axis, where the viewing device includes an indicator mechanism. The indicator mechanism is located substantially on the optical axis of the viewing device and is operable to display an indication to a user of the viewing device. The indicator mechanism is located in a position such that the viewing device does not form an image of the indicator mechanism.

In a further embodiment of the invention, an optical device includes a viewing device and an indicator mechanism. The viewing device is used by a user to view an image of a scene. The viewing device has a first optical element closest to the scene, a second optical element closest to the user, and an optical axis. The first and second optical elements are located on the optical axis. The indicator mechanism is located in a position substantially on the optical axis of the viewing device and proximate to a surface of one of the first and second optical elements.

In accordance with yet another embodiment, there is provided a visible indicator for use with a viewing device used by a user to view an image of a scene, where the viewing device has a field of view. The visible indicator includes an indicator mechanism that is located between the viewing device and the scene in the field of view of the viewing device. The indicator mechanism is operable to display an indication to the user within at least a part of the image of the scene.

Other technical features may be readily apparent to one skilled in the art from the following figures, descriptions, and claims.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts an optical system in accordance with the present invention;

FIGS. 2A and 2B show an indicator mechanism in accordance with the present invention;

FIG. 3 illustrates an indicator mechanism in accordance with the present invention; and

FIGS. 4, 5 and 6 depict indicator mechanisms according to the present invention.

### DETAILED DESCRIPTION

The present disclosure describes a device or system that provides a visible indicator in the field-of-view of a viewing device. Whether active or inactive, the indicator does not block a user's view of a scene while using the viewing device. The indicator is visible only to the user of the viewing device. The indicator is operable to provide a plurality of indications by the use of a plurality of colors, flash rates, on-off duty cycles, and/or intensities.

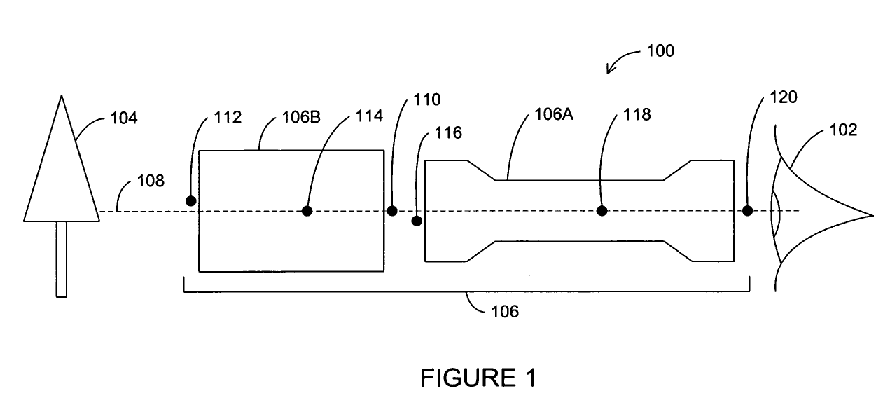

Now turning to FIG. 1, there is illustrated an optical system 100 in accordance with the present invention. A user 102 views a scene 104 using a viewing device 106, which includes a day scope 106A and night scope 106B. The day scope 106A is an optical system providing the user 102 with a magnified view of the scene 104, such as might be used to aim a rifle. The night scope 106B is an optical system providing image intensification, for use when the scene 104 is illuminated by low light levels. The day scope 106A and the night scope 106B have a common optical axis 108, which extends to the scene and to an image of the scene 104 viewed by the user 102. It will be understood that the optical axes of the day scope 106A and the night scope 106B may be offset from each other without departing from the scope of the invention.

The optical system 100 is a direct view system, because the user 102 looks directly into the day scope 106A to view the image of the scene 104. In other embodiments of the invention, an indirect view optical system may be used, where the image of the scene 104 is formed on a projection surface for the user 102 to view.

In still other embodiments of the invention, the viewing device may be a microscope, a telescope, or other optical system permitting the user 102 to view the scene 104. While in FIG. 1, the user 102 is shown viewing the scene 104 through both the day scope 106A and the night scope 106B, it will be understood that the user 102 may view the scene 104 through only the night scope 106B (to obtain image intensification without magnification) or the day scope 106A (to obtain magnification without image intensification) without departing from the scope of the invention.

The maximum extent of the scene 104 that may be viewed through the viewing device 106 is typically larger than the frontmost optical element of the viewing device 106. There is thus a cone spreading from the frontmost optical element to the scene 104 that encompasses all items that may be perceived, to some degree, by the user 102 of the viewing device 106. This cone is referred to as the field of view of the viewing device 106.

In the embodiment of the invention shown in FIG. 1, a light emitting diode (LED) 110 is an indicating mechanism that is operable to provide to the user 102 an indication of a status, an event, or other information. The LED 110 is located on the optical axis 108 and oriented to direct its light toward the user 102. Because the LED 110 is not located at a focal point of the optical system of the viewing device 106, an image of the LED 110 is not formed for the user 102. Neither the body of the LED 110, illuminated by ambient light, nor the light produced by the LED 110 appears as an image to the user 102.

When the LED 110 is not activated (i.e., is not producing light) it is invisible to the user 102. The LED 110 does not block any portion of the image of the scene 104. When the LED 110 is activated (i.e., is producing light) the user 102 perceives the LED 110 as a ‘wash’ of light over part or all of the image of the scene 104 that the user 102 is viewing. In some embodiments of the invention, the active LED 110 affects substantially all of the image; in other embodiments, it affects 25% or more of the image. If light from the LED 110 has a red color, then when the LED 110 is activated the user 102 will perceive all or part of the image of the scene 104 as having a red tint. If the light from the LED 110 is white, then the user 102 will perceive all or part of the image of the scene 104 as having a greater brightness and lower contrast.

In other embodiments of the invention, an indicator mechanism such as the LED 110 may be located at other positions in the optical system of the viewing device 106. Some of such locations are indicated by reference characters 112, 114, 116, 118 and 120. As may be seen from the positions indicated by reference characters 112 and 116, the indicator mechanism may be located off the optical axis 108. However, so long as the LED 110 is near enough to the optical axis 108 that its light enters the next optical element in the viewing device (or the user's eye, for position 120), the LED 110 is considered to be substantially on the optical axis 108.

Thus, when the LED 110 is activated it displays an indication to the user 102 by altering a color or intensity of all or part of the image of the scene 104 that the user 102 is viewing with the viewing device 106. Whether the indicator mechanism is located at position 110 or at positions 112-120, the indication does not block part of the image or otherwise significantly interfere with the view of the image. The indication is generally visible only to the user 102 because the light produced by the LED 110 is generally constrained within the day scope 106A.

Where the presence or absence of a single piece of information is to be conveyed to the user 102, its presence or absence is indicated by activating or deactivating, respectively, the monochromatic LED 110. In other embodiments of the invention, where the presence or absence of more than one piece of information is to be indicated, a multi-color LED may be used to indicate a first piece of information with a first color and a second piece of information with a second color. In such an embodiment, the presence of both pieces of information may be indicated by switching the LED from the first color to the second color and back again, or by activating the LED in the first color, deactivating the LED, activating the LED in the second color, deactivating the LED, etc.

In yet other embodiments of the invention, where an amount or value is to be conveyed to the user 102, other characteristics of the indication may be varied. A longer ‘on’ period and shorter ‘off’ period for a flashing indication may be used to signal a larger value, while a shorter ‘on’ period and longer ‘off’ period signal a smaller value. A faster flash rate of the indication may be used to signal a greater amount, while a slower flash rate signals a smaller amount. A brighter indication may signal a larger value, while a dimmer indication signals a smaller value.

In still other embodiments of the invention, a pattern of flashing may encode the information to be conveyed. For example, three brief flashes may indicate an incoming communication on radio channel 3. It will be understood that other variations and combinations of color, brightness, flash rate, duty cycle, intensity and pattern may be used to indicate status, events, levels, amounts, or other information in other embodiments of the invention.

In other embodiments of the invention, a sensor is used to measure a brightness of the image being viewed by the user 102. The measurement of brightness is then used to control the intensity of the indicator mechanism 110 to prevent its indication from overwhelming the image of the scene 104 being viewed by the user 102. The sensor may comprise a photodiode, a phototransistor, a photovoltaic cell, or other photo-sensitive device. Where the brightness of the image is sampled at a number of points, for example by a camera, gain-averaging software or hardware may be employed to determine an overall intensity of the image.

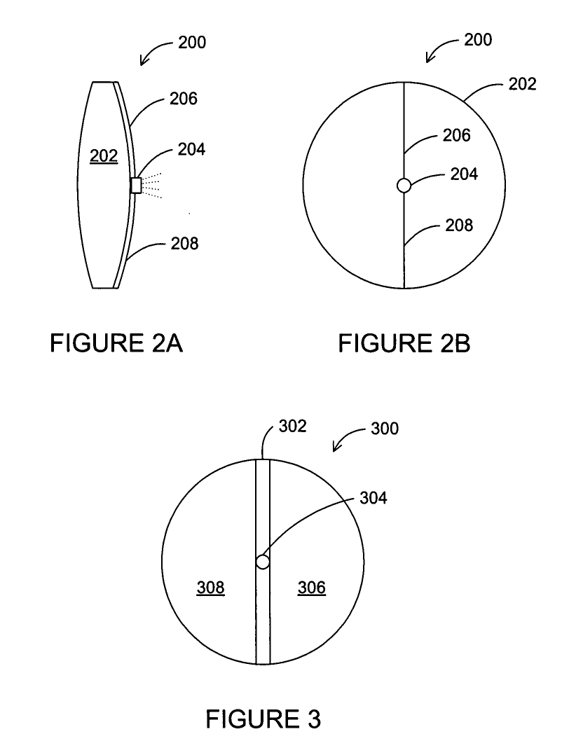

Now turning to FIG. 2A, there is shown an indicator mechanism 200 in accordance with the present invention. An indicator mechanism 204 is mounted to a surface of a lens 202 with an adhesive substance. Electrically coupled to the mechanism 204 are electrical conductors 206 and 208. The electrical conductors 206 and 208 are also mounted on a surface of the lens 202 with an adhesive substance. In the embodiment of the invention shown in FIG. 2, the indicator mechanism 204 is an LED and the electrical conductors 206 and 208 are anode and cathode conductors, respectively. In this way, via electrical conductors 206 and 208, the LED 204 may be electrically activated and deactivated.

FIG. 2B presents a schematic front view of the indicator mechanism 200. It may be seen in this view that the conductors 206 and 208 are wires. In other embodiments of the invention, the conductors 206 and 208 may be areas of transparent conductive coating applied to the surface of the lens 202. The LED may be attached to these conductive areas with solder, conductive epoxy, or similar. In still other embodiments of the invention, the wires 206 and 208 may be attached only to the LED 204 and to the periphery of the lens 202, and not to the surface of the lens 202 in between.

In other embodiments of the invention, the indicator mechanism 204 may be mounted to a surface of an optical element other than a lens, such as a sheet of protective glass that seals the optical system from external contamination. While the LED 204 is depicted as projecting light away from the lens 302, in other embodiments of the invention the mounting of the indicator mechanism 204 may be reversed, such that it projects light through the optical element 202 toward a user.

FIG. 3 illustrates an indicator mechanism 300 in accordance with the present invention. On a surface of a lens 302, regions 306 and 308 of clear conductive thin film have been deposited. An LED 304 is mounted in a position where its anode and cathode connections make electrical contact with the conductive thin film regions 306 and 308, respectively. A conductive solder or epoxy may be used to create these electrical connections In other embodiments of the invention, the regions 306 and 308 may have other shapes, covering less of the surface of the lens 302.

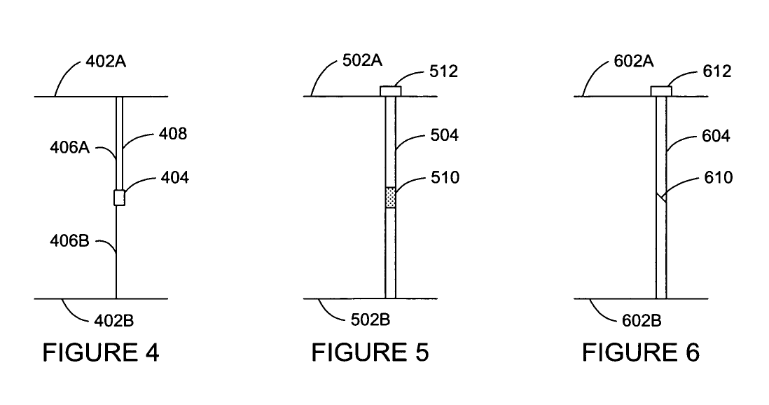

FIGS. 4, 5 and 6 depict indicator mechanisms according to the present invention that are not mounted to a surface of an optical element of a viewing device. In FIG. 4, an LED 404 is mounted between two walls 402A and 402B of a housing. Where the housing is a cylinder, 402A and 402B may indicate different portions of a single wall. The indicator mechanism 404 is mechanically supported by wire portions 406A and 406B. The wire portions 406A and 406B are segments of a single wire 406 that traverses the housing 402 between the walls 402A and 402B. The mechanism 404 is mounted to the wire 406 by adhesive or other mechanical coupling and is held in position by the wire 406. The wire 406 also serves as an electrical conductor and is electrically coupled to the anode connector of the LED 404. A wire 408 is electrically coupled to the cathode connector of the LED 404. In this way, via electrical conductors 406 and 408, the LED 404 may be electrically activated and deactivated.

In other embodiments, the indicator mechanism may be another type of electrically powered light-emitting device, such as an electroluminescent device. In yet other embodiments, the wire 406 serves only as a mechanical support for the indicator mechanism 404 and an additional wire is added to serve as the anode conductor for the mechanism 404. In still other embodiments, the wire portions 406A and 406B are separate wires that serve as the anode and cathode conductors for electrically activating the indicator mechanism 404. In such an embodiment, wire 408 is not needed as an electrical conductor.

FIG. 5 depicts another indicator mechanism 504 according to the invention. The mechanism is mounted between walls 502A and 502B of a housing. The mechanism 504 is generally clear. The mechanism 504 includes fluorescent material 510. An ultraviolet (UV) illuminator 512 is mounted to the wall 502A and optically coupled to the mechanism 504, such that UV light is projected only into the mechanism 504. When the illuminator 512 is activated, its UV light stimulates the material 510 to fluoresce and emit visible light. The indicator mechanism 504 is coated with a material that prevents the UV light from the illuminator 512 from escaping the mechanism 504 and reaching an eye of a user. However, the coating is transparent to visible light, so that the user may see the light from the material 510, when stimulated, and may view an image of the scene through the viewing device at all times.

FIG. 6 presents yet another indicator mechanism 604 according to the present invention. The mechanism is mounted between walls 602A and 602B of a housing. The mechanism 604 is generally clear. The mechanism 604 includes a reflective region 610. The region 610 may be fully or partially reflective. A visible light illuminator 612 is mounted to the wall 602A and optically coupled to the mechanism 604, such that light is projected only into the mechanism 604. When the illuminator 612 is activated, its light reflects from the region 610 toward a user.

It will be understood that, as described for the LED 110 in the embodiment of the invention shown in FIG. 1, the indicator mechanisms 204, 304, 404, 504 and 604 of FIGS. 2 through 6 may display an indication to a user by altering a color or intensity of all or part of an image of a scene that the user is viewing with a viewing device. The indicator mechanisms may utilize variations and combinations of color, brightness, flash rate, duty cycle, intensity and pattern to indicate status, events, levels, amounts, or other information. Furthermore, like the LED 110, the indicator mechanisms of FIGS. 2 through 6 may be located in any position where an image of the indicator mechanism is not formed for the user by the viewing device. Several such positions are indicated in FIG. 1. Also like the LED 110, the indicator mechanisms of FIGS. 2 through 6 may be located on or near an optical axis of the viewing device.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An optical device, comprising:
a viewing device used by a user to view an image of a scene; and
an indicator mechanism operable to display an indication to the user in at least a portion of the image,
wherein the indicator mechanism is located in a position such that, while viewing the image of the scene, the user does not view an image of the indicator mechanism.

2. The optical device of claim 1, wherein:
the viewing device has an optical axis, the scene and the image being located on the optical axis, and
the indicator mechanism is located substantially on the optical axis.

3. The optical device of claim 1, wherein the indicator mechanism further comprises a device operable in a first mode and a second mode, wherein:
in the first mode, the indication is visible to the user; and
in the second mode, the indicator mechanism does not block a portion of the user's view of the image of the scene.

4. The optical device of claim 1, wherein the indication is a change in one of color and brightness of the at least a portion of the image of the scene.

5. The optical device of claim 1, wherein the indicator mechanism is further operable to display a plurality of indications within the at least a portion of the image of the scene.

6. The optical device of claim 5, wherein the plurality of indications comprises a plurality of one of colors, flash rates, duty cycles, and intensities.

7. The optical device of claim 5, wherein the plurality of indications comprises a combination of two or more of colors, flash rates, duty cycles, and intensities.

8. The optical device of claim 1, wherein the indicator mechanism comprises a light emitting device.

9. The visible indicator of claim 1, wherein the indication affects more than 25% of the image of the scene.

10. The visible indicator of claim 1, wherein the indication affects substantially all of the image of the scene.

11. A method, comprising:
providing a viewing device, operable by a user to view an image of a scene;
locating an indicator mechanism in a position relative to the viewing device such that, while viewing the image of the scene, the user does not view an image of the indicator mechanism; and
displaying an indication to the user in at least a portion of the image using the indicator mechanism.

12. The method of claim 11, wherein the viewing device has an optical axis, the scene and the image being located on the optical axis, and locating the indicator mechanism further comprises locating the indicator mechanism substantially on the optical axis.

13. The method of claim 11, wherein locating the indicator mechanism further comprises locating the indicator mechanism such that the indicator mechanism does not block a portion of the user's view of the image of the scene.

14. The method of claim 11, wherein displaying an indication to the user further comprises changing one of color and brightness of the at least a portion of the at least a portion of the image of the scene.

15. The method of claim 11, wherein displaying an indication to the user further comprises displaying a plurality of indications within the at least a portion of the image of the scene.

16. The method of claim 15, wherein the plurality of indications comprises a plurality of one or more of colors, flash rates, duty cycles, and intensities.

17. An optical device, comprising:
a viewing device used by a user to view an image of a scene, the viewing device having an optical axis, wherein the scene and the image are located on the optical axis; and
an indicator mechanism operable to display an indication to the user within at least a part of the image of the scene,
wherein the indicator mechanism is located substantially on the optical axis of the viewing device in a position such that the user does not view an image of the indicator mechanism.

18. A viewing device having an optical axis, the viewing device comprising:
an indicator mechanism located substantially on the optical axis of the viewing device and operable to display an indication to a user of the viewing device, wherein the indicator mechanism is located in a position such that the viewing device does not form an image of the indicator mechanism.

19. An optical device, comprising:
a viewing device used by a user to view an image of a scene, the viewing device having a first optical element closest to the scene, a second optical element closest to the user, and an optical axis, wherein the first and second optical elements are located on the optical axis; and
an indicator mechanism, wherein the indicator mechanism is located in a position substantially on the optical axis of the viewing device and proximate to a surface of one of the first optical element and second optical element.

20. A visible indicator for use with a viewing device used by a user to view an image of a scene, the viewing device having a field of view, the visible indicator comprising:
an indicator mechanism located between the viewing device and the scene in the field of view of the viewing device and operable to display an indication to the user within at least a part of the image of the scene.
